(19) United States
(12) Patent Application Publication
(10) Pub. No.: US 2018/0108913 A1
(43) Pub. Date: Apr. 19, 2018

(54) CROSSLINKED POLYMERIC BATTERY MATERIALS

(71) Applicant: Navitas Systems, LLC, Woodridge, IL (US)

(72) Inventors: Pu Zhang, Ann Arbor, MI (US); Michael Wixom, Ann Arbor, MI (US); Hongxia Zhou, Ann Arbor, MI (US)

(21) Appl. No.: 15/557,337

(22) PCT Filed: Mar. 11, 2016
(86) PCT No.: PCT/US2016/022065

§ 371 Date: Sep. 11, 2017

Related U.S. Application Data
(60) Provisional application No. 62/158,119, filed on May 7, 2015.
(60) Provisional application No. 62/157,618, filed on May 6, 2015.
(60) Provisional application No. 62/131,279, filed on Mar. 11, 2015.

(51) Int. Cl. H01M 4/62; H01M 10/0525; H01M 2/16; H01M 4/04; H01M 4/525; H01M 4/505; C08J 3/24

(52) U.S. Cl. CPC H01M 4/622; H01M 10/0525; H01M 2/166; H01M 4/0416; C08J 2329/04; H01M 4/505; C08J 3/24; H01M 2220/20; H01M 4/525

(57) ABSTRACT

Provided are crosslinked or crosslinkable polymeric materials suitable for use as an electrode binder, separator, protector, or other uses in an electrochemical call. In some aspects, electrode materials are provided that include an electrode active material combined with a binder that is formed of crosslinked polymeric material, optionally crosslinked with lithium tetraborate. The binder material offers the ability to form electrodes in an aqueous solvent thereby bypassing the toxic solvents required by may prior binding systems. Also provided are processes of forming an electrode that include combining an electrode active material with a binder formed in part or wholly from a polymer and a crosslinker to form a slurry, and coating an electrically conductive substrate with the slurry to form the electrode. The binder material used in the processes is compatible with polymerization in an aqueous solvent and compatible with silicon based anode materials and cathode materials suitable for use in a lithium ion cell.

### CROSS REFERENCE TO RELATED APPLICATIONS

This application depends from and claims priority to U.S. Provisional Application No. 62/131,279 filed Mar. 11, 2015, U.S. Provisional Application No. 62/157,618 filed May 6, 2015, and U.S. Provisional Application No. 62/158,119 filed May 7, 2015, the entire contents of each of which are incorporated herein by reference.

### FIELD

This disclosure relates generally to materials and methods for their fabrication. In particular, the provided are materials having utility as binders for the fabrication of electrodes useful in electrochemical devices such as lithium batteries.

### BACKGROUND

Lithium ion battery electrodes are fabricated by casting slurries of active electrode material and polymer binders onto metal foil current collectors. The polymer binders serve multiple vital functions, including particle-to-particle cohesion, electrode-to-foil adhesion, and facile transport of lithium ions. The binder polymers must be electrochemically stable under strongly reducing (anode) or oxidizing (cathode) conditions, and thermally stable under cell production operations as well as under abusive operating conditions. In the case of emerging high capacity silicon-based anodes, the binder plays a further critical role in accommodating the large strain associated with lithiation and delithiation, which limits the cycle life of high energy lithium ion batteries.

In addition to these functional properties, binders must meet process compatibility requirements to be commercially viable. This entails the ability to obtain a high solid content slurry with stable rheological properties for adoption into high volume commercial coating operations. Water-soluble binders reduce coating operation cost by up to 50% by eliminating solvents and maximizing solids loading [JSR 2013].

The two established binder formulations are polyvinylidene difluoride (PVdF) binder in n-methyl pyrrolidone (NMP) solution, and styrene butadiene rubber (SBR) binder in aqueous latex suspensions. PVdF binder is the most prevalent in use, but it requires toxic solvent NMP, and it is not compatible with Si anode.

To eliminate toxic solvents, SBR/carboxymethyl cellulose (CMC) blends have been developed as a commercial aqueous binder. Other systems, such as CMC, polyacrylic acid (PAA), and polyvinyl alcohol (PVA) have been studied as aqueous binders as well. If being used alone, CMC, PAA, and PVA are very stiff materials that lead to aggregated or delaminated coatings, especially for high loading electrodes. In some cases, SBR is added to improve the structural integrity of the electrode. However, all these aqueous binders are weak absorbents of liquid electrolyte resulting in formation of a resistive interface for lithium ion transport, and thus, significant decrease of electrode conductivity. The aqueous binders are practically limited to electrodes that have low mass loadings and/or low strains because the conductivity and mechanical properties are inadequate for high loading films (such as high loading lithium metal oxide cathodes) and high strain films (such as Si based anodes).

Due to the shortcomings of the prior binder systems, new binder materials are needed. The crosslinked binder as provided herein is adhesive, flexible, mechanically strong, and intrinsically ion conductive. It enables a common binder chemistry for both high energy silicon anodes and high loading cathodes. This is believed to achieve a significant advance in both energy density and manufacturing cost.

### SUMMARY

The following is provided to facilitate an understanding of some of the innovative features unique to the present disclosure and is not intended to be a full description. A full appreciation of the various aspects of the disclosure can be gained by taking the entire specification, claims, drawings, and abstract as a whole.

It is a first object to provide a material suitable for use as a binder in an electrochemical cell that is conductive to ions (collectively referred to as binder). This object is achieved by providing an electrode suitable for use in an electrochemical cell that includes an electrically conductive substrate coated with an electrode active material in contact with a crosslinked polymer binder with a chemical structure capable of polymerization in an aqueous solvent. In some aspects provided include combinations of polymer and a crosslinker that can be partially or fully polymerized prior to or when mixed with an electrode active material to form a bound active material suitable for applying to a conductive substrate in the formation of an electrode. Some aspects include systems in which the binder includes a partially or fully crosslinked polyvinyl alcohol or derivative thereof. A polymer such as polyvinyl alcohol is optionally crosslinked with a crosslinker including a metal compound, an aldehyde, an organic acid, or combinations thereof. A crosslinker optionally includes lithium, a metal borate, or combinations thereof. In some aspects, a crosslinker is lithium tetraborate. The polymer and the crosslinker are optionally intermixed at a ratio of polymer to crosslinker from 1:1 to 100:1, optionally 4:1 to 16:1. The polymer in the binder optionally includes a functionalized polyvinyl alcohol optionally including polyvinyl alcohol polymer functionalized with a hydrophobic functional group of 1 to 6 carbons linked to the polyvinyl alcohol by an ether or ester bond. Optionally, the binder includes a functionalized polyvinyl alcohol comprising an intermediate degree of hydrolysis. In some aspects, a binder includes one or more polyvinyl alcohol copolymers, optionally a poly(vinyl alcohol-co-vinyl acetate) or poly(vinyl butyral-co-vinyl alcohol-co-vinyl acetate). In any of the foregoing, an electrode includes an electrode active material, optionally including or formed from silicon, Ni, Co, Mn, Mg, Fe, Ti, Al, a rare earth metal, an additive such as a carbon additive, or combinations thereof. Optionally, an electrode active material includes or is NCM-111, NCM-424, NCM-523, or NCA. The amount of electrode active material is optionally present at a weight percent of 50% or greater relative to the binder. A slurry of binder and electrode active material and binder optionally has a viscosity of 100 cPs to 10000 cPs. Optionally 1000 cPs to 6000 cPs. A slurry of binder and electrode active material optionally has a pH of 3 to 8.

It is another object to provide processes for forming materials suitable for use in an electrode of an electrochemical cell where the materials are conducting to ions. Such materials may be used as a binder for electrode active material, a separator, a protective film, or any combination thereof. These objects are provided by processes including combining an electrode active material with a binder comprising a polymer and a crosslinker to form slurry, and optionally coating an electrically conductive substrate with the slurry. The polymer may be any polymer with a functional group suitable for crosslinking in an aqueous solvent such as water where a functional group is optionally a hydroxyl or a carboxyl group. In some aspects, a polymer is or includes polyvinyl alcohol. A crosslinker optionally includes a metal compound, an aldehyde, an organic acid, or combinations thereof. A crosslinker optionally includes lithium, a metal borate, or combinations thereof. In some aspects, a crosslinker is or includes lithium tetraborate. Processes optionally include partially or fully crosslinking the polymer and the crosslinker in the presence of the electrode active material prior to coating on a substrate, following coating a substrate, or both. Optionally, a polymer is partially crosslinked with a crosslinker prior to or in the presence of an electrode active material and the crosslinking reaction may be completed following coating onto a substrate. A crosslinking step is optionally partially or fully achieved by adjusting the pH, optionally in the presence of a pH adjusting agent (e.g. any suitable acid or base). The polymer and crosslinker, and optionally electrode active material, are optionally combined in the presence of an aqueous solvent, optionally greater than 50% water by weight, optionally greater than 99% water by weight. An electrode active material used in the processes optionally includes silicon, carbon, nickel, cobalt, manganese, iron, titanium, aluminum, or combinations thereof. Optionally, an electrode active material includes or is NCM-111, NCM-424, NCM-523, or NCA. The amount of electrode active material is optionally present at a weight percent of 50% or greater relative to the binder. A slurry of binder and electrode active material and binder optionally has a viscosity of 100 cPs to 10000 cPs. Optionally 1000 cPs to 6000 cPs. A slurry of binder and electrode active material and binder optionally has a pH of 3 to 8.

A competitive advantage of the provided binder and processes is to enable longer life and higher electrode loading, primarily for anode materials that undergo high strain on lithiation/de-lithiation, but with benefits that extend to other lower strain anodes and high loading cathodes. This advantage is achieved by the introduction of a crosslinking agent that will strengthen the mechanical properties and enhance lithium ion transport of the electrodes.

### BRIEF DESCRIPTION OF THE DRAWINGS

FIG. 1 illustrates and exemplary crosslinked PVA binder incorporating a crosslinker (X) and with the presence of a hydrophobic functionalization group (R) on the polymer as well as incorporating at silicon-carbon composite electrode active material (oval);

FIG. 2 illustrates the increase in viscosity of PVA crosslinked by lithium tetraborate with increasing pH of the water solvent used in crosslinking;

FIG. 3A illustrates cyclic voltammetry of an anode formed on Cu foil at 0-3V with a crosslinked PVA binder tested at a scan rate of 2 mV/S at 25° C. with a Solartron S2-1287 station;

FIG. 3B illustrates cyclic voltammetry of a cathode formed on Al foil at 2-5V with a crosslinked PVA binder tested at a scan rate of 2 mV/S at 25° C. with a Solartron S2-1287 station;

FIG. 4 illustrates DSC of a crosslinked PVA binder material between 25-350° C. under N₂ on a TA Instruments DSC Q200 demonstrating polymer stability up to 260° C.;

FIG. 5 illustrates thermogravimetric analysis of a crosslinked PVA binder material between 25-400° C. under N₂ on a TA Instruments TGA Q500 demonstrating polymer stability up to 260° C.;

FIG. 6 illustrates anode surfaces formed using an XLPVA binder before and after soaking in electrolyte at 85° C. for 2 hours;

FIG. 7 illustrates the rate capability of Si composite anode with crosslinked PVA binder in half cells and baseline CMC-SBR binder;

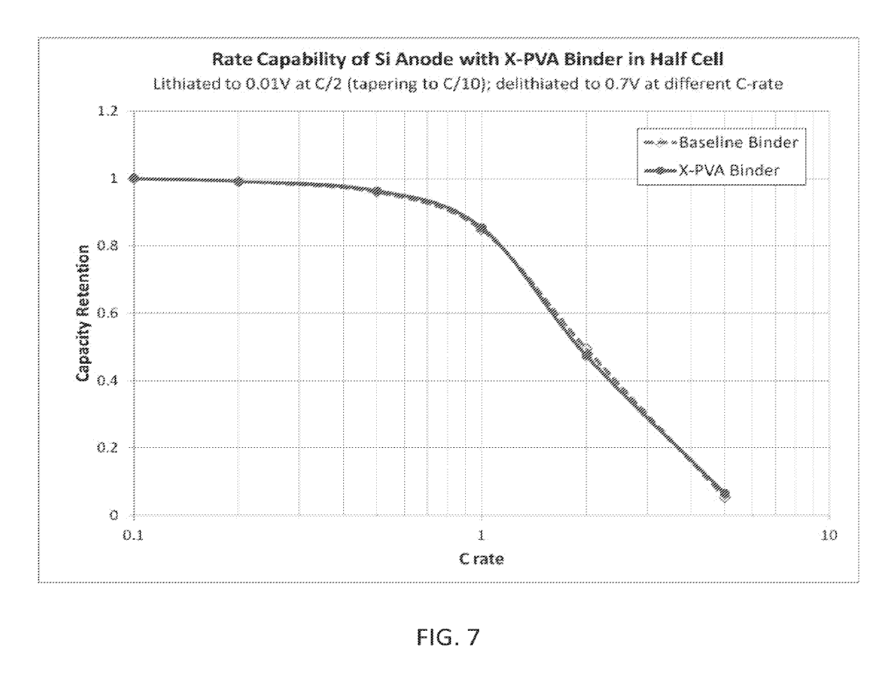

FIG. 8 illustrates cathode surfaces formed using an XLPVA binder before and after soaking in electrolyte at 85° C. for 2 hours;

FIG. 9 illustrates the rate capability of NCM523 cathode in half cells with XLPVA binder, baseline PVdF binder, and baseline SBR binder;

FIG. 10 illustrates the cycle life of NCM523 cathodes with various binders;

FIG. 11 illustrates rate capability of Si composite Li ion cells formed with different binders charged at C/2 rate to 4.2V (tapering to C/10) and discharged to 2.7V at various rates;

FIG. 12 illustrates cell capacity vs. cycle curves of NCA-Si composite Li ion cells with cell capacity of 260 mAh when cycled at 4.2-3.0V (100% DOD) where all the cells were charged at C/2 (tapering to C/15) and discharged at C/2 at room temperature;

FIG. 13 illustrates cycle life of NCA-Si composite Li ion cells where cell capacity was 260 mAh when cycled at 4.2-3.0V (100% DOD) and all the cells were charged at C/2 (tapering to C/15) and discharged at C/2 at room temperature; and

FIG. 14 illustrates cycle life improvement of Si anode with XLPVA binder vs. CMC-SBR baseline in a pouch cell.

### DETAILED DESCRIPTION

The following description of particular aspect(s) is merely exemplary in nature and is in no way intended to limit the scope of the invention, its application, or uses, which may, of course, vary. The disclosure is described with relation to the non-limiting definitions and terminology included herein. These definitions and terminology are not designed to function as a limitation on the scope or practice of the disclosure but are presented for illustrative and descriptive purposes only.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

An “active material” is a material that participates in electrochemical charge/discharge reaction of the battery such as by absorbing or desorbing an ion such as hydrogen, lithium, sulfur or other ion.

Provided are low-cost aqueous ion-conducting binders demonstrated to excel in both Si-based and high energy nickel containing electrodes such as lithium nickel-cobalt-manganese oxide (e.g. NCM 523) or lithium nickel cobalt aluminum (NCA) applications and also is useful for other electrode applications such as graphite, LTO, conversion material electrodes, and combinations thereof. The binders retain high mechanical, chemical, and electrochemical stabilities in a Li ion battery environment. The binders as provided herein such as the crosslinked polyvinyl alcohol (PVA) binders show higher thermal stability (>250° C.) relative to baseline binders (i.e., 170° C. for PVdF and 120° C. for SBR). The binders may be used in either or both an anode or cathode and provide for electrode coatings to an aggressive loading of 4 mAh/cm² that are suitable for electric vehicle (EV) batteries and other high energy applications. For an NCM cathode, NCM 523 as one example, greater than 50% cycle life improvement was demonstrated in half cells. For a Si anode, greater than 25% cycle life improvement was demonstrated in full Li ion cells (capacity greater than 200 mAh) relative to cells with the same electrode active materials using a conventional binder.

Provided are crosslinked polymer binders that are adhesive, flexible, mechanically strong, and intrinsically ionic conductive. Table 1 summarizes the advantages of an exemplary crosslinked PVA (XLPVA) binder vs PVdF and SBR binder systems. Table 1 also includes comparisons to CMC, PAA, and non-crosslinked PVA binders that are being promoted for silicon-based anodes and high loading lithium metal oxide cathodes.

TABLE 1
Comparison of Lithium Ion Battery Binders (++ is best, −− is worst, 0 is neutral).

| | | | | Mechanical | | |
|---|---|---|---|---|---|---|
| | | | | Strength of | | |
| | Process | Adhesion/ | Si Anode cycle | LMO | Thermal | Ionic |
| Binder Type | Cost | cohesion | life | cathode | Stability | Conductivity |
| PVdF | −− | ++ | −− | ++ | − | + |
| SBR | 0 | + | + | + | − | − |
| CMC or PAA | ++ | −− | ++ | −− | ++ | − |
| PVA | ++ | − | ++ | −− | ++ | − |
| XLPVA | ++ | ++ | ++ | ++ | ++ | ++ |

A significant technical challenge in working with conventional binders is attaining robust mechanical linkage without completely coating the electrode particles and blocking transport of lithium ions to and from the surface. Therefore, a key innovative aspect of the provided binder is use of a polymer with a composition and conformation that supports lithium ion transport through a contiguous film. The ionic conductivity of a XLPVA binder as an exemplary provided binder measured at room temperature was ˜5×10⁻³ S/cm. The XLPVA binder, thus, overcomes the inherent drawbacks of PVdF- and SBR-based binders that are limited to very thin (a few nm) or discontinuous layers in order to facilitate lithium ion transfer from the electrolyte to the particles. Furthermore, prior PVdF binders are cast from NMP solutions and require high-cost drying and solvent recovery operations. The innovative crosslinked binders as provided herein have a higher glass transition temperature, melting point and thermal stability than PVdF or SBR. The crosslinking strategy also generates value through better abuse tolerance and through enabling more aggressive drying operations which will increase production throughput.

As such, a binder for an electrode active material for use in an electrochemical cell is provided. A binder includes an ion conducting and optionally water soluble organic polymer formed from an organic polymer or copolymer (collectively “polymer” as further used herein unless otherwise indicated) and a crosslinker that combine to form the ion conducting binder. A binder is optionally capable of conducting lithium ions through the polymer network. A binder in some aspects is capable of absorbing common electrolytes including carbonate based electrolytes.

A binder includes one or more polymers. Optionally, a polymer is a water soluble polymer. A polymer optionally includes one or more available functional groups suitable for use in a crosslinking reaction. Illustrative examples of functional groups present on a polymer include hydroxyl, carboxyl, or combinations thereof one or more of the same or differencing polymers. Illustrative examples of water soluble polymers include water-soluble polymer, polyvinyl alcohol, carboxymethyl cellulose, polyvinyl pyrrolidone, polyacrylic acid, polymethacrylic acid, polyethylene oxide, polyacrylamide, —N-isopropylacrylamide, poly-N, N-dimethylacrylamide, polyethyleneimine, polyoxyethylene, poly (2-methoxyethoxy-ethylene), poly vinyl sulfonic acid, polyvinylidene fluoride, amylose, and combinations thereof. In some aspects, a polymer material used in a binder includes polyvinyl alcohol (PVA), polyacrylic acid (PAA), poly-(methacrylic acid), carboxymethyl cellulose, hydroxypropylmethylcellulose, and polymethyl methacrylate (PMMA), or combinations thereof and optionally excludes other polymeric materials. Illustratively a polymer that forms a component of a binder has a molecular weight of 10,000 Daltons or higher. Such polymers, optionally those containing PVA, PAA, or PMMA, are commercially available. The commercially available PVA polymers may have varying degrees of hydrolysis of vinyl acetate. The polymers optionally have a high polymerization degree, optionally of more than 3000. A binder material optionally excludes materials other than a polymer and crosslinker, and optionally excludes an electrolyte.

A polymer used in the provided binders is capable of associating with a crosslinker to form a binder suitable for use with a non-aqueous electrolyte. The crosslinker is used to crosslink the polymer to form an organic polymeric binder material. In an exemplary system, a PVA polymer is used to form a binder by crosslinking its hydroxyl groups through condensation reaction. In an exemplary system, a PVA polymer is crosslinked by a mechanism essentially as follows:

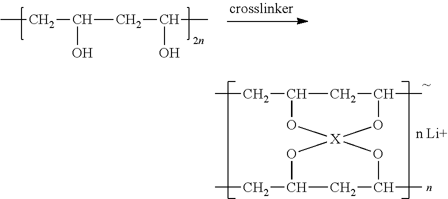

where X is a metal. In some aspects, a crosslinker has a formula LiMₓO_{y} where M is a metal, and x and y are such that the equation is satisfied depending on the elements in the material as recognized by one of ordinary skill in the art. In some aspects, a crosslinker includes a metal such as boron, chromium, titanium, zirconium, antimony, or combinations thereof. In some aspects, a crosslinker is lithium tetra borate (Li₂B₄O₇) (LTB). A crosslinker may be an aldehyde (with acid as a catalyst), for example, glutaraldehyde with hydrochloric acid. A crosslinker can be an organic acid such as maleic acid, maleic anhydride, citric acid, tartaric acid, oxalic acid, acrylic acid, polyacrylic acid, or combinations thereof. The crosslinker can be a metallic compound such as sodium tetraborate decahydrate (BORAX). Although all the said crosslinkers are suitable to form crosslinked PVA polymer, a Li+ incorporated crosslinker, such as LTB, is one particular example for Li ion battery systems as such crosslinked polymer binder has intrinsic Li ion conductivity.

When used as a binder, the viscosity and extent of crosslinking of the binder material were discovered to greatly affect the ability of the material to function. As such, a crosslinked binder material is optionally formed with a polymer to crosslinker molar ratio of 1:1 to 100:1, optionally 4:1 to 20:1. Optionally, a molar ratio of polymer to crosslinker is in excess of 4:1 but less than 16:1. Optionally, a molar ratio of polymer to crosslinker is 4:1 to 16:1, 5:1 to 16:1, 6:1 to 16:1, 7:1 to 16:1 8:1 to 16:1, 9:1 to 16:1, 10:1 to 16:1, 11:1 to 16:1, 12:1 to 16:1, 13:1 to 16:1, 14:1 to 16:1, or 15:1 to 16:1.

A binder is used to hold electrode active material and optionally inactive material together. As such, a binder is optionally used with one or more electrode active materials. An electrode active material is optionally useful as a cathode or an anode in an electrochemical cell. An electrode includes an electrode base material. An electrode base material is optionally suitable for use in formation of an anode or a cathode. In some aspects, an electrode active material optionally includes silicon, silicon carbon composites, tin, Ni, Co, Mn, Mg, Ge, Sb, Al, Bi, As, Li metal, lithium alloys, lithium metal oxides, lithium metal phosphates, metal alloys illustratively alloys of Ni, transition metal oxides, nitride materials, fluorine materials, sulfide materials, one or more electrically conductive additives such as a carbon additive illustratively graphitic carbon, and combinations thereof. An alloy optionally includes one or more of Mg, Fe, Co, Ni, Ti, Mo, and W.

Illustrative examples of a metal alloy for use as an electrode active material include silicon alloys. A silicon alloy is optionally and alloy of silicon and Ge, Be, Ag, Al, Au, Cd, Ga, In, Sb, Sn, Zn, or combinations thereof. The ratio of the alloying metal(s) to silicon is optionally 5% to 2000% by weight, optionally 5% to 500% by weight, optionally 20% to 60% by weight, based on silicon.

In some aspects, an electrode active material includes a lithium alloy. A lithium alloy optionally includes any metal or alloy that alloys with lithium, illustratively including Al, Si, Sn, Ag, Bi, Mg, Zn, In, Ge, Pb, Pd, Pt, Sb, Ti, tin alloys, and silicon alloys.

Examples an active material for use in a cathode include layered compounds such as lithium cobalt oxide (LiCoO₂) and lithium nickel oxide (LiNiO₂), or compounds substituted with one or more transition metals; lithium manganese oxides such as compounds of Formula Li₁₊ₓMn₂₋ₓO₄ (0≤x≤0.33), LiMnO₃, LiMn₂O₃ and LiMnO₂; lithium copper oxide (Li₂CuO₂); vanadium oxides such as LiV₃O₈, V₂O₅ and Cu₂V₂O₇; Ni-site type lithiated nickel oxides of Formula LiNi₁₋ₓMₓO₂ (M=Co, Mn, Al, Cu, Fe, Mg, B or Ga, and 0.01<x<0.3); lithium manganese composite oxides of Formula LiMn₂₋ₓMₓO₂ (M=Co, Ni, Fe, Cr, Zn or Ta, and 0.01≤x≤0.1), or Formula Li₂Mn₃MO₈ (M=Fe, Co, Ni, Cu or Zn); LiMn₂O₄ wherein a portion of Li is substituted with alkaline earth metal ions; disulfide compounds; and Fe₂(MoO₄)₃; LiFe₃O₄; NCM based materials (e.g. NCM111, NCM424, NCM523); NCA (e.g. Ni_{0.8}Co_{0.15}Al_{0.05}O₂); etc.

Additional examples of alloys and methods of alloy production can be found in U.S. Pat. No. 6,235,427.

In some aspects, the electrode active material is or includes: silicon; carbon and graphitic carbon materials such as natural graphite, graphene, artificial graphite, expanded graphite, carbon fibers, hard carbon, carbon black, carbon nanotubes, fullerenes and activated carbon; a composite material of a metal or metal compound and a carbon or graphite material whereby a metal optionally includes lithium and silicon; and a lithium-containing nitride. Carbon or carbon containing materials may be an additive to other active materials such as by intermixing or other, may be a coating, or both. Optionally, an electrode active material is not graphite alone in the absence of silicon, lithium, or a metal. In some aspects, an electrode active material is a composite material of silicon and graphitic carbon that may or may not include a carbon coating and or thermal treatment to stabilize the adhesion of the coating to the surface. In some aspects, an electrode active material includes a coating, illustratively a carbon coating. A carbon coating, when present, is a component of an over coating upon the electrode active material. The pre-deposition of a carbon coating provides enhanced electronic conductivity and may also promote adhesion of the ionic polymer base material when used as a binder in the formation of an electrode.

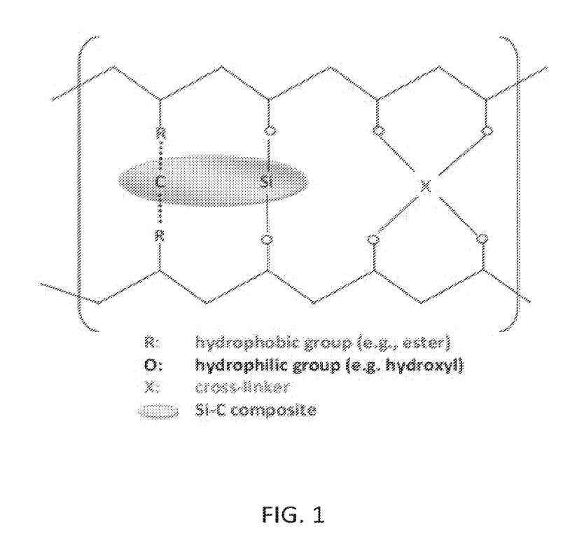

The binder optionally includes a polymer that is functionalized to optimize the suitability of the binder material to the particular electrode active material used. For example, Si composites, predominantly Si-carbon composites, are attractive anode materials for next generation high energy Li ion batteries. These materials can be generally divided to two classes: (1) Si grown on the surface of carbon (such as OneD Materials SiNANOde Si-graphite powder) and (2) Si impregnated into or mixed with graphite (such as 3M Si alloy-graphite composite and micro-sized porous Si composite by Navitas Systems). An exemplary binder as provided herein for class 1 is the XLPVA binder. However, also provided are functionalized binders such as functionalized XLPVA binders that have improved properties for use with class 2 active materials. Functionalized XLPVA binders including one or more functionalization groups illustratively functionalized by the addition of one or more hydrophobic functionalization groups. A hydrophobic functionalization group is optionally an organic molecule of 1 to 6 carbons, optionally 2 to 6 carbons, optionally including an ester or ether linkage to the polymer backbone. A hydrophobic functionalization group optionally includes a hydrocarbon molecule of 1 to 6 carbons, optionally 2 to 6 carbons, where the hydrocarbon is either linear or branched and optionally including an ester or ether linkage to the polymer backbone. Such a system improves crosslinking with both silicon and carbon present in class 2 active materials. (See FIG. 1 for example.)

In some aspects, a functionalized polymer with an intermediate hydrolysis degree (e.g. 70%-98%) may be used. Optionally, a functionalized polymer with a high hydrolysis degree (e.g. >98%) may be used, optionally with a degree of hydrolysis of greater than 99%.

In some aspects, PVA co-polymers may be used, illustratively poly(vinyl alcohol-co-vinyl acetate) or poly(vinyl butyral-co-vinyl alcohol-co-vinyl acetate). In some aspects, PVA polymer blends may be used. An illustrative example of such blends include polyvinyl alcohol/polyvinyl acetate (PVA/PVAc) blends optionally prepared in solution to vary the two types of functional groups ranging from 20:80 to 80:20 (molar ratio).

The electrode active material prior to combination with a binder may be in any physical form such as a particulate (e.g. powder), nanowire, sheet, nanotube, nanofiber, porous structure, whisker, nanoplatelet, or other configuration known in the art.

An electrode active material intermixed with a binder material may or may not be associated with an electrically conductive substrate. When associated with a substrate, the substrate is optionally formed of any suitable electronically conductive and impermeable or substantially impermeable material, including, but not limited to, copper, stainless steel, titanium, or carbon papers/films, a non-perforated metal foil, aluminum foil, cladding material including nickel and aluminum, cladding material including copper and aluminum, nickel plated steel, nickel plated copper, nickel plated aluminum, gold, silver, any other suitable electronically conductive and impermeable material or any suitable combination thereof. In some aspects, substrates may be formed of one or more suitable metals or combination of metals (e.g., alloys, solid solutions, plated metals). Optionally, an electrode active material is not associated with a substrate.

An electrode active material is optionally in contact with a binder material in the formation of an electrode. Furthermore, the electrode active material is optionally employed with a binder material when forming an electrode by processes readily understood in the art. In some aspects, a binder is formed in situ such as when the polymer is crosslinked in the presence of an electrode active material such that the electrode active material is allowed to migrate through the binder prior to or during crosslinking. A polymer and a crosslinker are optionally combined without crosslinking. Crosslinking can be initiated following the combination of the polymer and the crosslinker by processes known in the art such as by controlling temperature, pH, exposure to electromagnetic energy (e.g. light) of a desired characteristic, or other process known in the art. In some aspects, a polymer is crosslinked with the electrode active material present. In other aspects, a polymer is crosslinked either partially or totally prior to combining with an electrode active material. Optionally, the viscosity of the polymer or binder is adjusted to a desired level to accommodate electrode active material deposition onto a current collector or other substrate, or other as desired. Optionally, a binder is partially crosslinked to a particular viscosity for coating in the formation of an electrode and then crosslinking is optionally completed after the coating or casting process.

The electrode active material may be used in an electrode for a primary or a secondary battery. An electrode is optionally fabricated by suspending an electrode active material in a crosslinked binder, a partially crosslinked binder, or with a polymer and a crosslinker that are substantially not reacted (i.e. no active steps toward promoting polymerization have been taken) in a solvent to prepare a slurry, and applying the resulting slurry to a current collector by coating, spin-coating, or spray-coating depending on its viscosity, followed by drying (heat, microwave, or other drying process known in the art), and optionally pressing.

An electrode is formed by crosslinking of the binder with the active in an aqueous solvent. Prior systems required toxic solvents such as NMP that are detrimental to final electrode function. The binders as provided herein may be polymerized using aqueous solvents for binder crosslinking and optionally electrode manufacture. As such, water is an exemplary solvent. Additional examples of the solvent used in preparation of the electrode may include, but are not limited to carbonate-based, ester-based, ether-based, ketone-based, alcohol-based, or aprotic solvents. Specific organic solvents such as dimethyl sulfoxide (DMSO), N-methyl pyrrolidone (NMP) and ethylene glycol, and distilled water may optionally be used. Water or other aqueous solvents (e.g. buffered aqueous systems) may be used. In some aspects, NMP is excluded.

One aspect of a binder is its ability to function and be formed in water as a solvent used in electrode preparation. Particularly with cathode preparation, prior polymeric binders required organic solvents such as N-methyl-2-pyrrolidinone (NMP). Polyvinylidene fluoride (PVdF) binder is the most prevalent in use, but it requires toxic solvent N-methyl-2-pyrrolidinone (NMP) and is not compatible with emerging silicon-based anodes. The ability of the provided binders to be formed in a water based material solves the long standing need to replace organic solvent based binder systems and for the first time creates a compatibility for silicon based anodes.

Non-crosslinked polymer with low degree of polymerization (DP), for example, may dissolve in the electrolyte during long term cycling (Japanese Patent Laid-open Publication No. Hei 11-67215). Non-crosslinked PVA with high DP is stable in the electrolyte but has very low solubility in water that makes it very difficult to be used as an aqueous binder. In contrast to these prior systems, the binder as provided herein optionally uses crosslinked PVA that has the same solvent resistance as the PVA with high DP, while being processible as an aqueous solution. Testing of an exemplary binder shows no dissolution of a XLPVA film after 7 days soaking in a Li ion electrolyte at 60° C.

In some aspects, the viscosity of a binder material is modified. It was found that the amount of solid material (e.g. electrode active material) is limited by the viscosity of the binder. Without control of viscosity using XLPVA binders the upper limit of solids was found to be 50%. As such, a binder optionally has a viscosity measured at 20° C. using a rheometer (TA Instruments AR2000 at 100 rpm of less than 200 cPs, optionally less than 150 cPs, optionally less than 100 cPs, optionally less than 50 cPs, optionally less than 20 cPs.

By controlling the viscosity of the binder material during formation it was found that a much higher degree of solid electrode active material incorporation can be achieved in the electrode slurry. As such, the solid content of the said electrode slurry is optionally any value from 20% by weight to at or greater than 80% by weight. Optionally, the solid content is 20% by weight to 90% by weight, optionally, 30% to 90% by weight, optionally 50% to 90% by weight, optionally greater than 50% by weight.

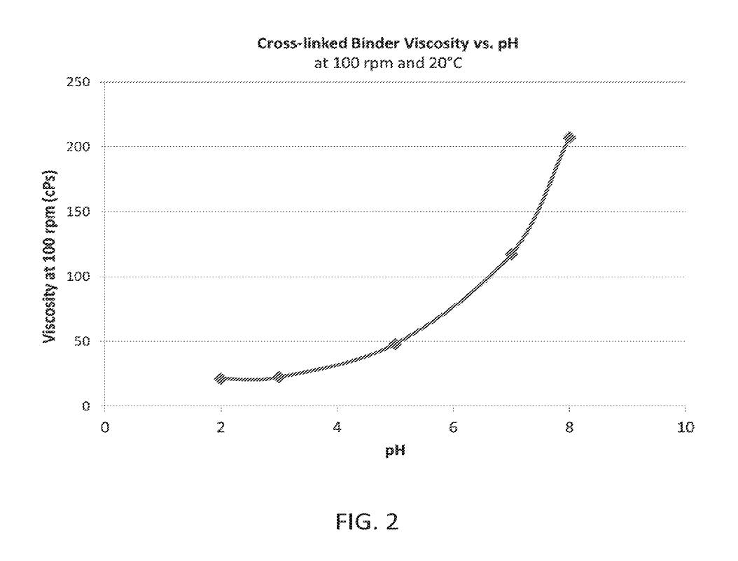

One method to control the viscosity of the crosslinked polymeric binder is to control the pH of the system during polymerization. The polymer crosslinking level (and viscosity) of crosslinked PVA (as an example) is strongly affected by pH as illustrated in FIG. 2. Without pH adjustment, the fully crosslinked polymer binder has the highest viscosity (3% solution, pH=8, Viscosity=220 cPs). The viscosity (i.e., crosslinking level) drops as the pH is lowered and stays at ˜20 cPs when pH is <3. For reference, a non-crosslinked 3% PVA solution itself has a viscosity of 8 cPs. As such, in some aspects a two stage crosslinking process is used in the formation of an electrode binder and optionally an electrode. Optionally, a partially crosslinked binder solution is formed by adjusting the pH to between 3 and 7 by addition of oxalic acid, resulting in controllable low viscosity binder. The partially crosslinked binder may then be mixed with electrode active material (e.g. cathode powder) and optionally conductive carbon to prepare a slurry. The slurry may have high solid content (e.g. >60%) while still having a viscosity suitable for coating a conductive substrate. The slurry may be coated onto a substrate, such as Al foil, using a slot-die coater. The coater may contain a sequence of heated drying zones to dry the coating. The last drying zone temperature is optionally >120° C., high enough to evaporate oxalic acid. The crosslinking process of the binder will continue to completion in the drying zone upon modifying the pH, for example by removal or neutralization of the acid. No additional crosslinking or curing step will be needed. Completion of the crosslinking will ensure the electrode attains the desired properties for long term cycling.

A viscosity of the electrode slurry with a crosslinked or partially crosslinked or non-crosslinked binder material and electrode active material is optionally from 100 cPs to 10000 cPs. Optionally a viscosity of the electrode slurry is from 1000 cPs to 6000 cPs, or any value or range therebetween.

Also provided are processes of forming an electrode, optionally an anode, optionally a cathode, using an electrode active material as described herein and a binder. A process includes providing an electrode active material. The electrode is formed by placing a desired polymer in an aqueous medium that is then combined with an aqueous solution of crosslinker at a desired ratio. A ratio is any ratio as described herein. The electrode active material is optionally immersed in the solution of the polymer and crosslinker whereby the polymer and crosslinker bind the electrode base material optionally during crosslinking, prior to crosslinking, or after crosslinking to form the electrode material. The binding is optionally done at elevated temperature, optionally from 30° C. to 70° C. or any value or range therebetween to enhance the mobility and accessibility of polymer to the electrode base material. Optionally, the formation is done at 50° C. A formation time is used that is optionally between 5 to 90 minutes, or any value or range therebetween, optionally 15 minutes.

Subsequent processing steps of the bound electrode active material are optionally included, illustratively filtration and rinsing to remove unattached active material. The resulting bound electrode active material is optionally dried, illustratively for subsequent use in an electrochemical cell. A resulting electrode material is optionally free of additional binder material other than the crosslinked binder as provided herein. As such, in some aspects, an electrode material uses as the sole binder material a crosslinked polymeric binder as provided herein.

Also provided are crosslinked polymeric materials used as a separator, solid electrolyte, or a protection layer for electrodes such as lithium metal absorbing/desorbing electrodes. A separator as used herein may refer to functions of separating an anode from a cathode, a solid electrolyte, or a protective layer. The improved ability of the crosslinked polymer binder as provided above is similarly achieved when such a material is provided in the absence of an electrode active material contained therein such as when the crosslinked polymer is used as a separator. The same benefits of improved ion conduction are realized when the polymers are used in such a way that electrochemical cells may employ such systems as a separator, electrolyte, or protection layer either alone, together, or also combined with electrodes that employ the crosslinked polymeric materials as a binder. As such, the provided crosslinked polymer used as a binder described herein above may be provided with the same properties but formed in the absence of an electrode active material.

To form a separator, protector, solid electrolyte or other ion conducting material, a polymer is combined in an aqueous solvent as described herein in the presence of a crosslinker at an appropriate ratio as described above. Crosslinking of the polymer is performed to a desired level of crosslinking to producing a material suitable for inclusion in an electrochemical cell.

An electrochemical cell is also provided that uses an electrode formed of an electrode active material bound with a polymeric crosslinked binder substantially as provided by the aspects as described herein, a separator as provided herein, an electrolyte as provided herein, a protector as provided herein, or any combination thereof. The bound electrode active material is optionally used alone or is associated with a substrate. In some aspects, the electrochemical cell includes an anode, a cathode, and an electrolyte where the anode, cathode or both include an electrode active material bound by a crosslinked polymer binder as provided herein.

Also provided is an electrochemical cell that includes an anode, a cathode, an electrolyte and a separator where the separator is formed of a crosslinked polymer material as provided herein. A separator optionally further includes one or more fillers, optionally one or more ceramic fillers. A filler is optionally one or more of LiAlO₂, Al₂O₃, MgO, TiO₂, CaCO₃, among others, and combinations thereof.

In some aspects provided is an electrochemical cell that includes an anode, a cathode, an electrolyte, and a separator where the anode, cathode, or both include a crosslinked polymer binder as provided herein and where the electrochemical cell includes a separator formed of a crosslinked polymer material as provided herein. The crosslinked polymer material used in the binder of the cathode, anode, and separator may have the same or differing chemistries, degree of polymerization, degree of crosslinking, differing crosslinkers or other.

An electrochemical cell includes an electrolyte. An electrolyte is optionally a solid or fluid electrolyte. Illustratively, the electrolyte includes a lithium salt and a non-aqueous organic solvent. A lithium salt is optionally LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiCl, LiI, or LiB(C₂O₄)₂ (lithium bis(oxalato) borate; LiBOB). The lithium salt is optionally present in a concentration ranging from about 0.1 M to about 2.0 M. When the lithium salt is included at the above concentration range, an electrolyte may have excellent performance and lithium ion mobility due to optimal electrolyte conductivity and viscosity.

An electrochemical cell may be in any suitable form such as a pouch cell, cylindrical cell, prismatic cell, or other configuration known in the art.

The resulting electrode active materials bound with the crosslinked polymeric binder are suitable as anode or cathode material for inclusion in an electrochemical cell. Among the many advantages of the crosslinked polymeric binder materials, the resulting electrode material is resistant to physical degradation that is common of silicon based materials when cycling with lithium thereby increasing cycle life and reducing the rate of capacity fade.

The aspects presented herein are a notably significant advance over the nearest methods, which includes binder crosslinking described in patents by LG (U.S. Pat. No. 8,585,921 B2), as well as previous use of binder crosslinking as a means to manage creep in thermoset gel polymer electrolyte systems. For the first time, the provided crosslinked polymer binder uses a crosslink chemistry that facilitates lithium ion transport.

Various aspects of the present invention are illustrated by the following non-limiting examples. The examples are for illustrative purposes and are not a limitation on any practice of the present invention. It will be understood that variations and modifications can be made without departing from the spirit and scope of the invention. While the examples are generally directed to silicon particulate as an electrode base material, it is understood that other electrode base materials are similarly used. Reagents illustrated herein are commercially available, and a person of ordinary skill in the art readily understands where such reagents may be obtained.

### Experimental

### Formation of a Polymeric Binder

The starting material, polyvinyl alcohol (99+% hydrolyzed, Mw 89,000-98,000 or Mw 31,000-50,000, Sigma, St. Louis, Mo.) and the crosslinker (lithium tetra borate (Li₂B₄O₇) Sigma), are dissolved in water separately to a concentration of 3% PVA and 4% LTB. Two solutions present in a range of controlled ratios (PVA:LBO=16:1, 8:1, 4:1, or 2:1) are mixed together with vigorous stirring for 15 min at room temperature (solution has a pH=8). The solution becomes viscous as crosslinking reaction proceeds instantaneously. The solution concentration, polymer to crosslinker ratio, mixing speed, and reaction temperature are adjusted as control variables. Neat binder films were produced by casting the resulting XLPVA solutions on glass plates and drying them in air. The films were then peeled from the glass plates after they were dry. The films were transparent and colorless.

### Chemical Stability

The polymer binder must retain adhesion and cohesion under long-term immersion in an electrolyte without dissolution or decomposition. Non crosslinked PVA with a low degree of polymerization (DP) (less than 2000 units) may dissolve in the electrolyte during long term cycling. Non crosslinked PVA with high DP (e.g. greater than 2000 units) is stable in the electrolyte, but its low solubility in water makes it very difficult to use as an aqueous binder. Crosslinked PVA is desired to be both processible as an aqueous binder and stable in electrolyte solvents.

Solvent resistance of the XLPVA binder was demonstrated by soaking the binder film coated on a glass substrate as above in an electrolyte (LiPF₆ in EC:EMC (3:7)) at room temperature and at 60° C. Chemical stability is assessed as change of mass of the recovered and dried films after 7 days. As shown in the Table 2, the weight loss after soaking test was <0.6% which exceeded the target of <1%.

TABLE 2
Crosslinked PVA binder stability in electrolyte

| | | | Weight |
|---|---|---|---|
| Sample | Weight (mg) | | Loss |
| Number | Before Soak | After Soak | (%) |
| 1 | 38.0 | 37.8 | 0.53 |
| 2 | 99.3 | 98.7 | 0.60 |
| 3 | 182.6 | 181.5 | 0.60 |
| Average | | | 0.58 |

### Electrochemical Stability

Cyclic voltammetry (CV) of the XLPVA binder was carried out on a two-electrode cell. A 3% XLPVA binder solution was cast on a current collector with a doctor blade. (i.e., Cu for anode or Al for cathode). The electrode was dried. The dry binder coating thickness was controlled to be 2 micrometers by adjusting doctor blade gap.

Lithium foil was used as counter and reference electrode. The measurement was done between 0-3V (vs. Li⁺/Li) for the polymer mounted Cu cell or 2-5V for the Al cell. All the tests were at a scan rate of 2 mV/S at 25° C. with a Solartron S2-1287 station.

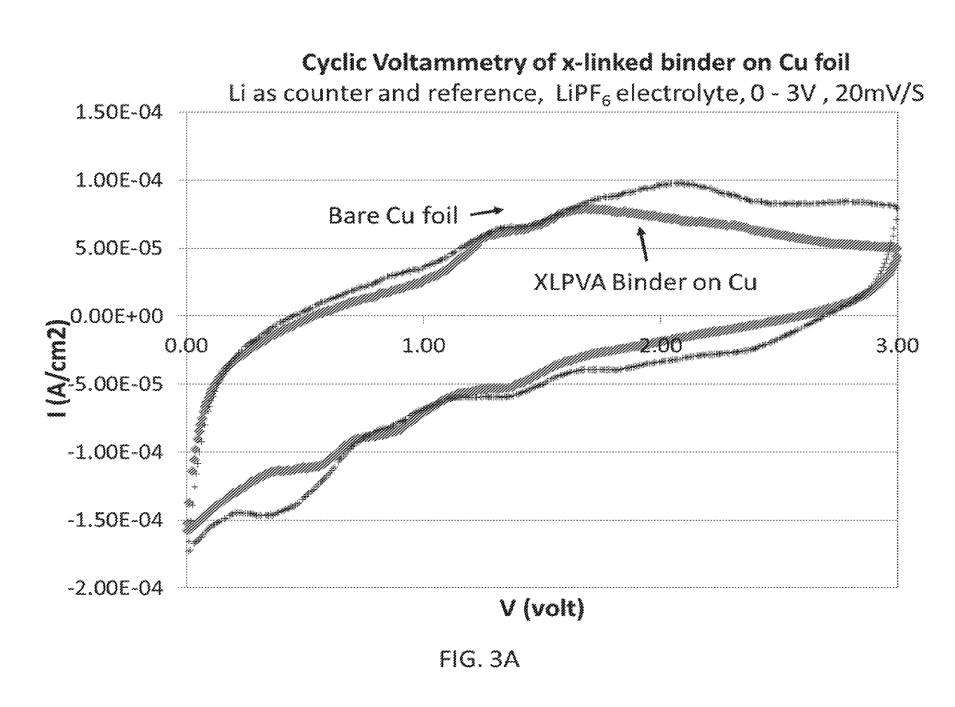

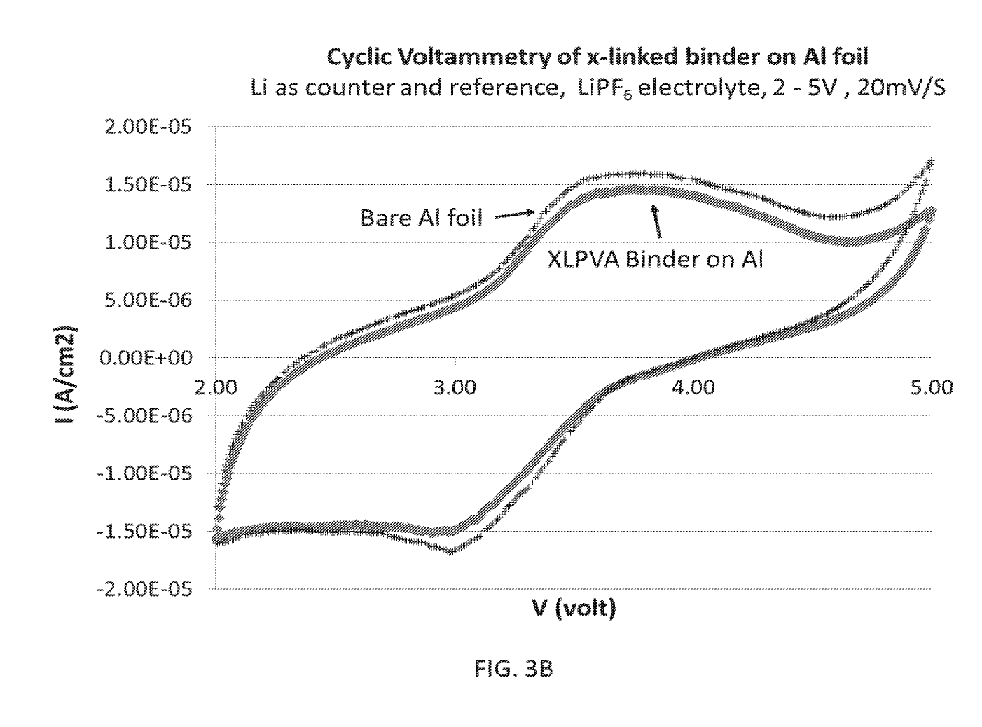

In comparison to bare metal electrodes, the electrodes with binder films did not show any additional features (or side reactions) between 0-3V on Cu and 2-5V on Al and showed only slightly lower current than the bare electrodes during the scan (FIGS. 3A and B).

### Thermochemical Stability

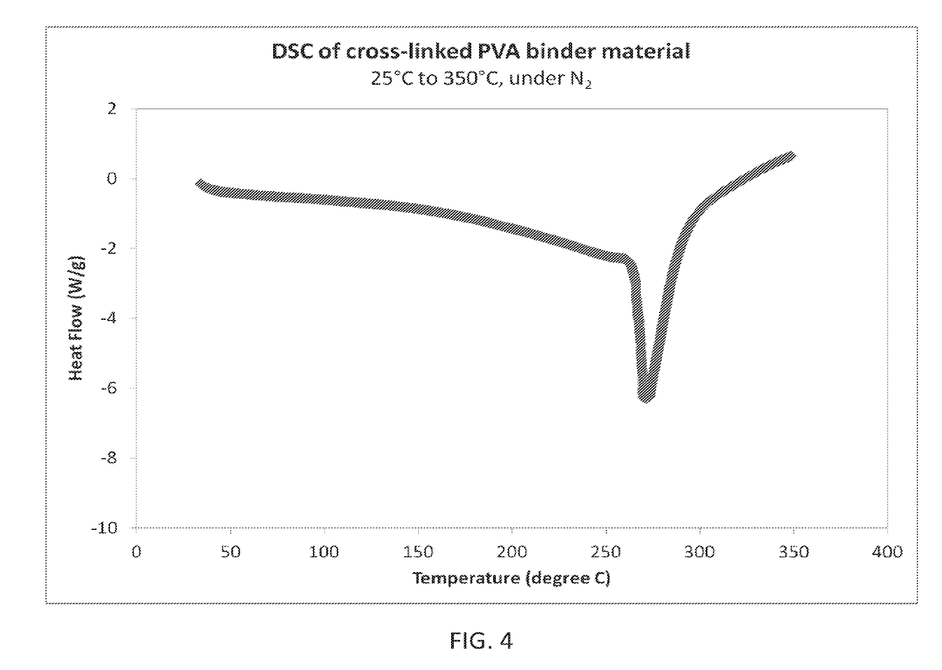

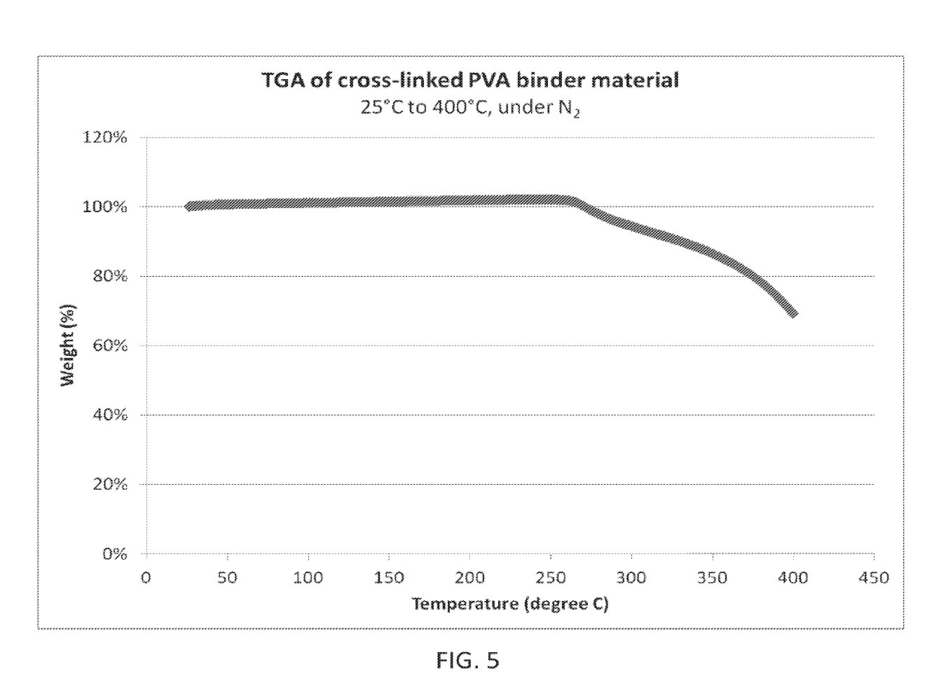

Differential Scanning Calorimetry (DSC) (FIG. 4) and Thermogravimetric Analysis (TGA) (FIG. 5) were conducted on the polymer samples to characterize their thermomechanical stability. DSC was performed using a TA Instruments DSC Q200 (between 25-350° C.) and TGA was performed using a TA Instruments TGA Q500 (between 25-400° C.) under N₂. Both measurements confirm that the XLPVA is thermally stable up to 260° C., significantly higher than the baseline PVdF (170° C.) and SBR (120° C.) binders. The excellent thermomechanical stability suggests that XLPVA binders will result in higher abuse tolerance.

### Electrode Fabrication Using XLPVA Binder

Bench scale slurry casting was used to produce electrodes. The novel XLPVA binder required formulation and process development for both the anode and cathode. The slurry mixing conditions were adjusted to obtain a coatable formulation for high energy cell electrode loading.

For production of a Si anode, a commercially available silicon-graphite composite material (OneD Material SiNANOde 8% Si content) with a capacity of 550 mAh/g was selected. PVA polymer and the crosslinking agent (lithium tetraborate) were dissolved in water separately. The crosslinker solution (4%) was then added to the polymer (3%) with molar ratio of 1:4. It was stirred vigorously for 15 minutes at room temperature. The resulting XLPVA solution with a pH of 8 was used as a binder. The anode active material and conductive carbon was mixed with the binder to make a slurry (active:carbon:binder=94:1:5 by weight) by using A Flacktec SpeedMixer. The slurry viscosity and stability was checked by using a rheometer (TA Instruments AR2000). Electrodes were cast using a TMI K-control doctor blade coater and dried in a vaccum oven. To coat high loading anodes (i.e., 4 mAh/cm²) with desirable properties (physical and electrochemical), the coating conditions were investigated by evaluating the following variables:

1) PVA molecular weight 89 k-98 k

2) PVA solution concentration (3%)

3) PVA to crosslinker molar ratio 4:1

4) Conductive carbon content <5% (1% used in example)

5) Binder content <8% (5% used in example)

6) Slurry solid content 25%-40% (31% used in example)

The electrodes were qualified for adhesion and flexibility using the following established standard operating procedures for production electrode quality assurance:

Mandrel Test:

The test unit was set up by placing a mandrel bar (size of 2, 3, and 4 mm) between two rollers. An electrode sample was slit to 4″ long. Holding the electrode at each end, the sample was rolled back and forth over mandrel bar 5 or 6 times. There was no cracking or delamination observed on the electrode surface after the test (Grade 1, passed).

Hot Electrolyte Test:

In a standard operation, three pieces of 2″×3″ electrode are soaked in electrolyte (1M LiPF₆ in EC:EMC 3:7) at 85° C. for 2 hours while contained in a sealed pouch. The electrode is removed from the pouch and blotted dry with a paper towel. On patted-dry electrodes, the operator uses the end of a razor blade and gently scrapes the electrode.

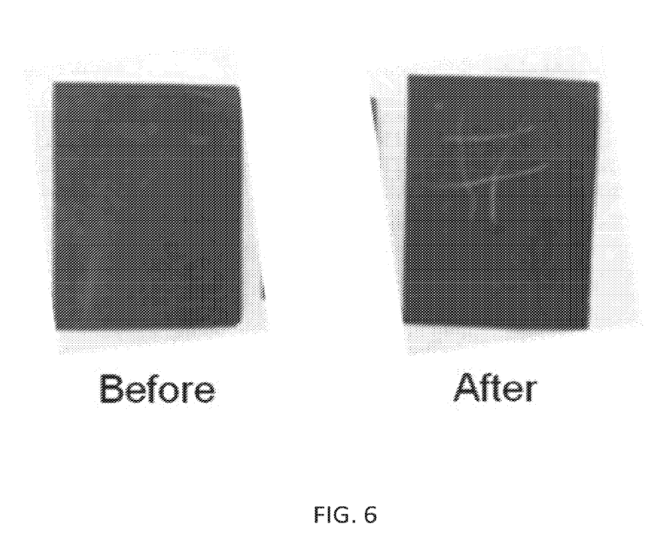

FIG. 6 shows the anode surfaces before and after the hot electrolyte test. The samples showed scraping marks only under the razor blade tips and no delamination was observed (Grade 1, passed).

Electrochemical Properties

Anode:

To make anode with XLPVA binder, the active material and conductive carbon was mixed with the above prepared binder to make a slurry by using A Flacktec SpeedMixer. The slurry composition was “active:carbon:binder=94:1:5 by weight”. The slurry viscosity and stability was checked by using a rheometer (TA Instruments AR2000). Electrodes were cast using a TMI K-control doctor blade coater and dried in a vaccum oven.

To make baseline anode with CMC-SBR binder, the active material and conductive carbon was mixed with CMC solution (Daicel 2200, 2.7 wt %) to make a slurry by using A Flacktec SpeedMixer. The SBR (styrene butene rubber, Zeon BM480B, 40% solid) was then added to the slurry and mixed by using the same mixer. The slurry composition was “active: carbon:CMC:SBR=94:1:3:2 by weight”. The slurry viscosity and stability was checked by using a rheometer (TA Instruments AR2000). Electrodes were cast using a TMI K-control doctor blade coater and dried in a vaccum oven.

The XLPVA anode and baseline CMC-SBR binder anode (comparator control) were assembled into Li half coin cells. The following test protocol was used to determine capacity, initial capacity loss (ICL), and rate capability:

1) Discharge to 0.01V at constant current of C/20, then taper to C/50 at constant voltage of 0.01V (CCCV)

2) Charge to 2.0V at constant current of C/20 (CC)

3) Record discharge capacity (lithiation) and charge capacity (delithiation or reversible) and calculate ICL as “1−(charge capacity/discharge capacity)”

The anode with the XLPVA binder showed no difference in capacity or ICL from the baseline, which confirms the stability of the XLPVA binder in such electrochemical environment.

TABLE 3
Capacities and ICL for XLPVA binder and comparator:

| | Lithiation | Delithiation | |
|---|---|---|---|
| | Capacity | Capacity | ICL |
| Binder | (mAh/g) | (mAh/g) | (%) |
| XLPVA | 628 | 568 | 10 |
| CMC- | 628 | 567 | 10 |
| SBR | | | |

Electrode rate capability was also evaluated in Li half cells. The cells were discharged (lithiated) to 0.01V at C/2 rate (CV hold to C/10) and charged (delithiated) to 0.7V at different C-rates. The XLPVA binder performed the same as the comparator: >95% at 0.5 C and >85% at 1 C (FIG. 6).

Cathode:

To make a NCM 523 cathode with XLPVA binder, the active material (for example available from BASF) and conductive carbon was mixed with the XLPVA binder to make a slurry by using A Flacktec SpeedMixer. The slurry composition was “active:carbon:binder=92:4:4 by weight”. The slurry viscosity and stability was checked by using a rheometer (TA Instruments AR2000). Electrodes were cast using a TMI K-control doctor blade coater and dried in a vaccum oven.

To make a NCM 523 cathode with PVdF binder (baseline 1), the active material and conductive carbon was mixed with Kureha 7208 binder (PVdF, 8%) to make a slurry by using A Flacktec SpeedMixer. The slurry composition was “active:carbon:binder=92:4:4 by weight”. The slurry viscosity and stability was checked by using a rheometer (TA Instruments AR2000). Electrodes were cast using a TMI K-control doctor blade coater and dried in a vaccum oven.

To make a NCM 523 cathode with SBR binder (baseline 2), the active material and conductive carbon was mixed with CMC solution (Daicel 2200, 2.7 wt %) to make a slurry by using A Flacktec SpeedMixer. The SBR (styrene butene rubber, Zeon BM480B, 40% solid) was then added to the slurry and mixed by using the same mixer. The slurry composition was “active:carbon:CMC:SBR=92:4:2:2 by weight”. The slurry viscosity and stability was checked by using a rheometer (TA Instruments AR2000). Electrodes were cast using a TMI K-control doctor blade coater and dried in a vaccum oven.

The cathodes were qualified for adhesion and flexibility using the same procedures as used for the anode. All the electrodes passed the dry adhesion and wet adhesion tests. Similar to the anodes, there was no delamination observed.

The XLPVA binder cathode and baseline PVdF binder cathode were assembled into Li half coin cells to check the capacity and initial capacity loss (ICL) with the following test protocol:

1) Charge to 4.3 V at constant current of C/20, then tapering to C/50 at constant voltage of 4.3 V (CCCV)

2) Discharge to 2.7V at constant current of C/20 (CC)

3) Record charge capacity and discharge capacity (or reversible) and calculate ICL as “1−(discharge capacity/charge capacity)”

The cathode with the XLPVA binder showed no difference on tests of capacities and ICL from the comparator, which confirms the stability of the XLPVA binder in such electrochemical environment.

TABLE 4
Capacities and ICL of NCM cathodes with
XLPVA binder and PVdF baseline binder.

| | Lithiation | Delithiation | |
|---|---|---|---|
| | Capacity | Capacity | ICL |
| Binder | (mAh/g) | (mAh/g) | (%) |
| XLPVA | 182 | 160 | 12 |
| PVdF | 182 | 161 | 12 |

The electrodes are validated independently in coin half cells versus lithium metal and in Li ion pouch cells versus baseline production-quality counter-electrodes. All the cells are assembled using semi-automated pilot cell production equipment in the dry room at Navitas, Ann Arbor development facility.

Prototype cells are evaluated using the following tests and protocols:

Capacity and Energy:

Cell capacity and energy are tested first at low C-rate (C/10) on Maccor automated cycler. The specific energy (Wh/kg) is calculated based on the voltage, current, and time of the charge/discharge curves, and weight of the Li-ion cell. The results are compared with the theoretical capacity and energy. The C/10 capacity and energy are used as the baseline for subsequent rate capability and cycle life tests.

Rate Capability:

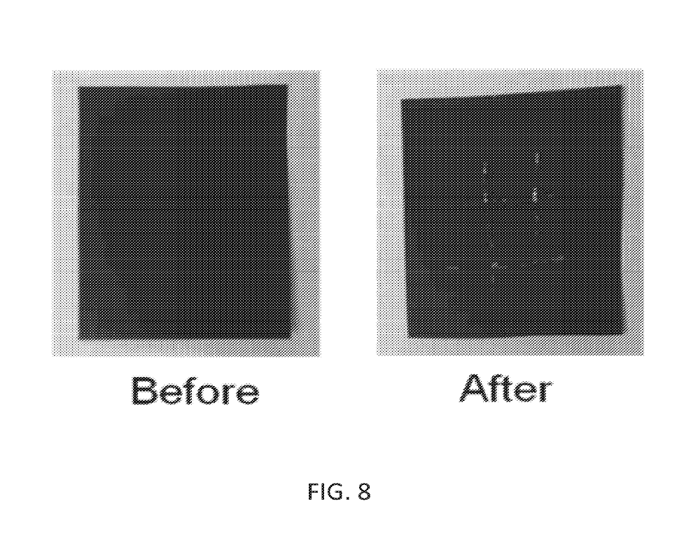

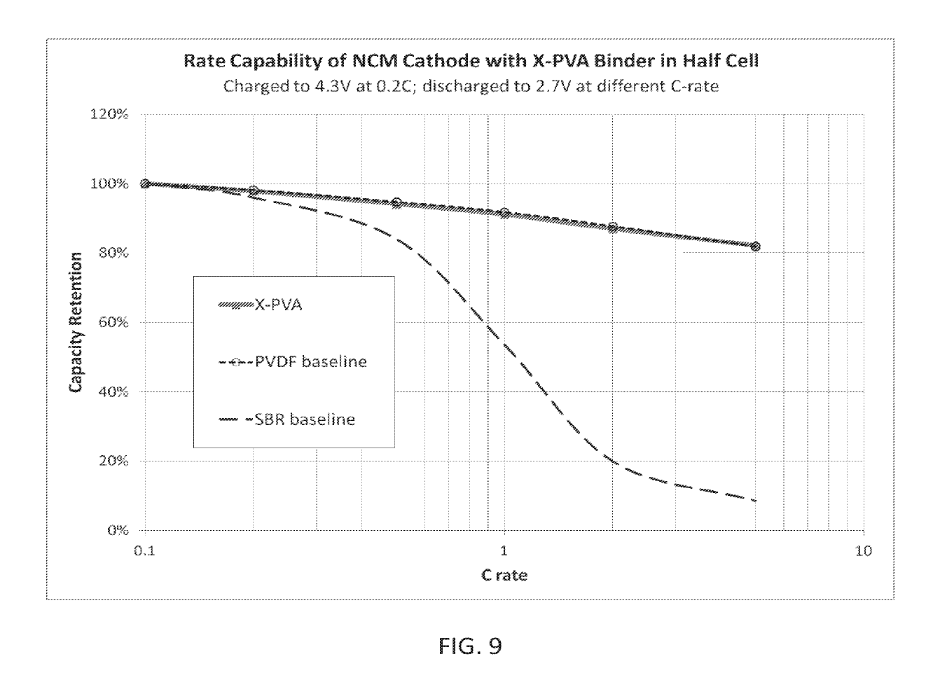

Both charge and discharge capacity are measured at incrementally higher C-rates (C/10, C/5, C/2, 1 C, 2 C, 5 C, and 10 C) to evaluate the rate capability. Electrode rate capability was also evaluated in Li half cells. The cell was charged to 4.3V at C/5 rate (CV hold to C/20) and discharged to 2.7V at different C-rates. The XLPVA binder performed the same (two lines appear directly overlaid) as the baseline PVdF binder and much better than the baseline SBR aqueous binder (FIG. 9). The rate retention results confirm the low impedance of the new aqueous binder. The crosslinked PVA binder enables high loading electrode fabrication >4 mAh/cm² without sacrificing performance as illustrated in FIG. 8 demonstrating that for the NCM Cathode Half Cell Rate Capability: X-PVA binder=PVdF binder>>SBR binder.

Cycle Life:

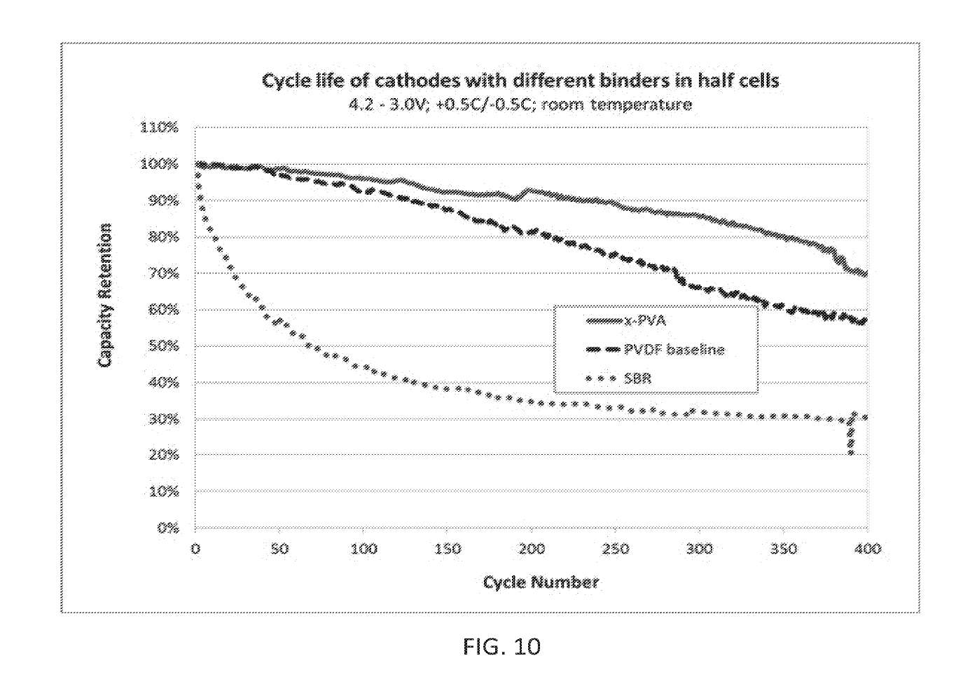

Cathodes were fabricated using XLPVA (aqueous solution), PVdF (NMP solution), and SBR (aqueous suspension) and evaluated in coin half cells. The cells were cycled at C/2 rate between 4.2-3.0 V. The cycle life rating is: XLPVA binder>PVdF binder>>SBR binder. The cell with SBR binder decayed rapidly and the capacity dropped to below 50% after 100 cycles and the other two binders performed much better (FIG. 10A). The PVdF baseline cell ran 212 cycles before it reached 80% capacity retention, while the crosslinked PVA cell ran 350 cycles before it reached 80% capacity retention. A 65% improvement of XLPVA cathode cycle life over the PVdF baseline has been demonstrated.

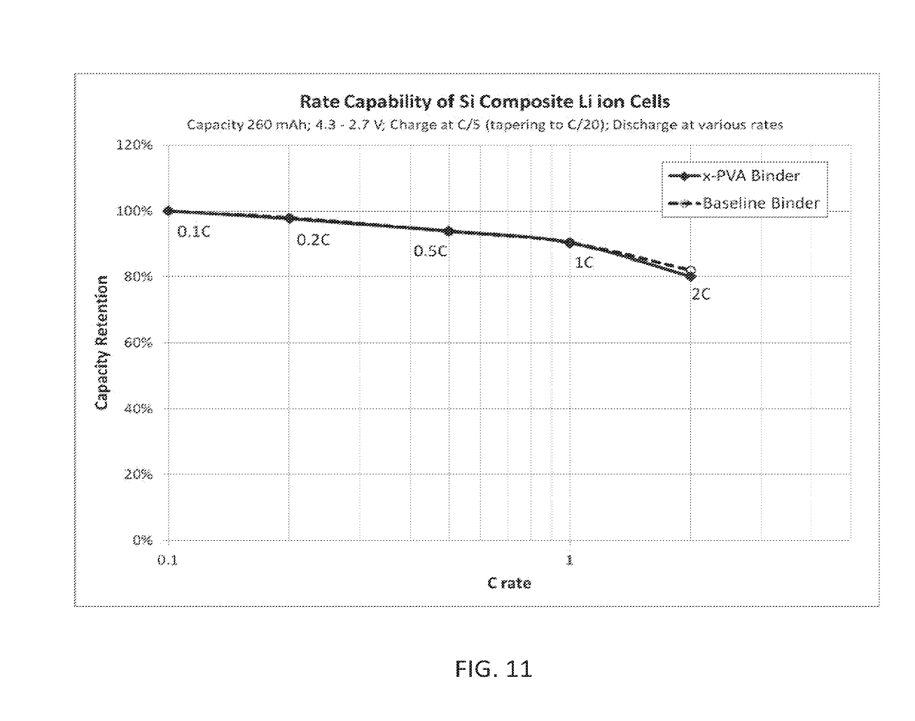

Lithium ion pouch cells were assembled with NCA cathode and Si anode. Si anodes were fabricated with XLPVA binder and CMC-SBR baseline binder. Toda NAT-1050 lithium nickel cobalt aluminate (NCA) cathodes were prepared to match the anode capacity. The cell size was designed to have a capacity of >250 mAh for reliable electrochemical performance evaluation. The cells were assembled in the dry room following the standard operation procedures. All cells showed initial capacities of 260 mAh when cycled between 4.2-3.0V at C/2 rate. Rate capability tests were conducted between 4.3-2.7V. Capacity retention exceeded 95% at 0.5 C and 90% at 1 C for both the XLPVA and the baseline binder cells (FIG. 11).

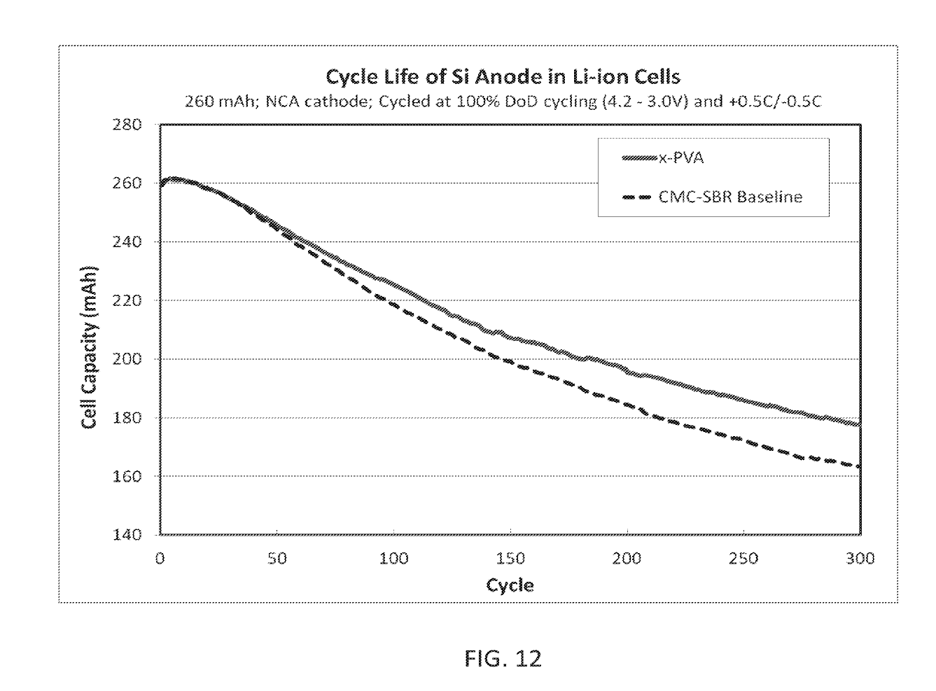

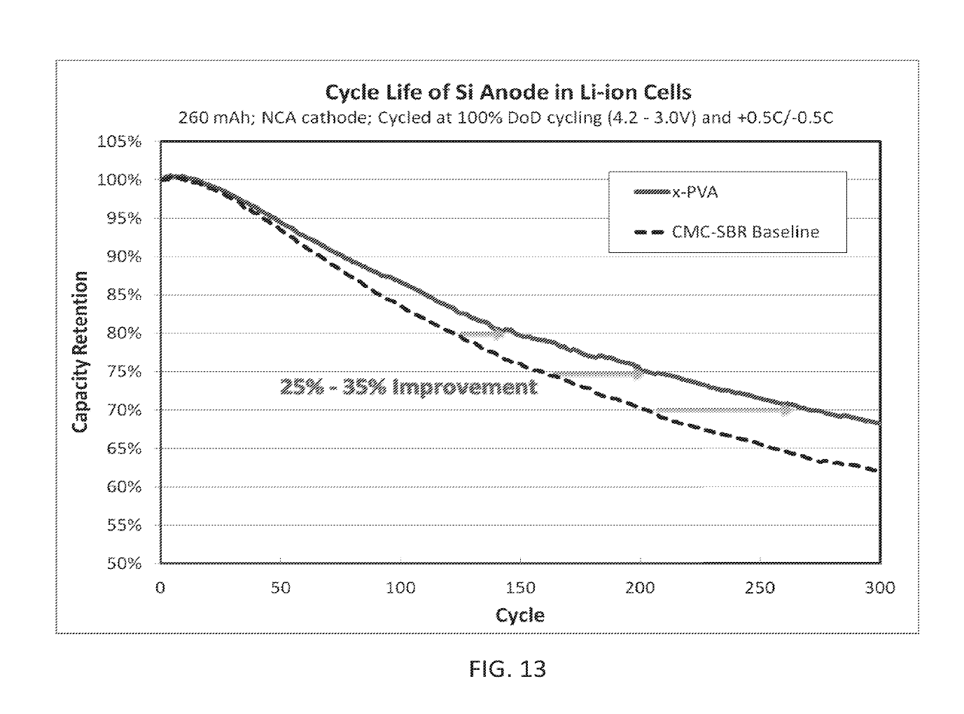

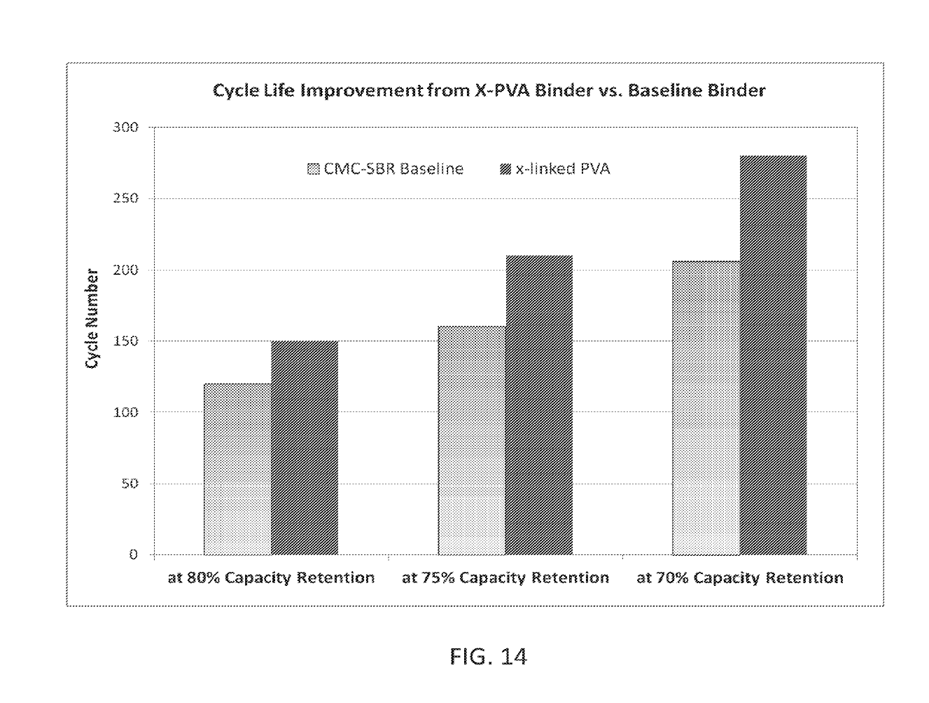

Cell capacity vs. cycle curves are shown in FIG. 12 and capacity retention curves are in FIG. 13. Each curve shows average value of three cells. The cycle life improvement for the XLPVA binder over the baseline binder is shown in Table 5 and FIG. 14. A 25%-35% improvement has been demonstrated.

TABLE 5
Cycle life of pouch cells with
electrodes formed using various binders.

| | Cycles | Cycles | Cycles |
|---|---|---|---|
| | at 80% | at 75% | at 70% |
| Si anode binder | retention | retention | retention |
| CMC-SBR | 120 | 160 | 206 |
| XLPVA | 150 | 210 | 280 |
| Improvement (%) | 25 | 30 | 35 |

### Performance of Crosslinked Polymer Binder in LCO Electrodes

For production of a lithium cobalt oxide (LCO) electrode, a commercially available LCO material (Umicore KD20S) was selected. The LCO powder and conductive carbon was mixed with the XLPVA binder (as per above) to make a slurry by using A Flacktec SpeedMixer. The slurry composition was “active:carbon:binder=92:4:4 by weight”. The slurry viscosity and stability was checked by using a rheometer (TA Instruments AR2000). Electrodes were cast using a TMI K-control doctor blade coater and dried in a vaccum oven.

The resulting electrodes were analyzed for adhesion using the hot electrolyte test. In a standard operation, three pieces of 2″×3″ electrode are soaked in electrolyte (1M LiPF₆ in EC:EMC 3:7) at 85° C. for 2 hours while contained in a sealed pouch. The electrode is removed from the pouch and blotted dry with a paper towel. On patted-dry electrodes, the operator uses the end of a razor blade and gently scrapes the electrode. There was no cracking or delamination observed on the electrode surface after the test illustrating a grade 1 response (pass).

The LCO electrodes were tested for reversible capacity relative to a traditional PVdF binder prepared electrode in coin half cells versus lithium metal and in Li ion pouch cells versus baseline production-quality counter-electrodes. Cell capacity is tested first at low C-rate on Maccor automated cycler. The cells were cycled at C/2 rate between 4.2-3.0 V. The LCO electrodes using the XLPVA binder show similar reversible capacity relative to LCO electrodes formed using PVdF as a binder. (145 mAh/g for XLPVA binder electrodes and 146 mAh/g for PVdF binder electrodes).

### Performance of Crosslinked Polymer Binder in NCA Electrodes

For production of a lithium nickel cobalt aluminum (NCA) electrode, a commercially available NCA material (Toda, NAT-1050) was selected. The NCA powder and conductive carbon were mixed with the XLPVA binder (as per above) to make a slurry by using A Flacktec SpeedMixer. The slurry composition was “active:carbon:binder=92:4:4 by weight”. The slurry viscosity and stability was checked by using a rheometer (TA Instruments AR2000). Electrodes were cast using a TMI K-control doctor blade coater and dried in a vaccum oven.

The resulting electrodes were analyzed for adhesion using the hot electrolyte test. In a standard operation, three pieces of 2″×3″ electrode are soaked in electrolyte (1M LiPF₆ in EC:EMC 3:7) at 85° C. for 2 hours while contained in a sealed pouch. The electrode is removed from the pouch and blotted dry with a paper towel. On patted-dry electrodes, the operator uses the end of a razor blade and gently scrapes the electrode. There was no cracking or delamination observed on the electrode surface after the test illustrating a grade 1 response (pass).

The NCA electrodes were tested for reversible capacity relative to a traditional PVdF binder prepared electrode in coin half cells versus lithium metal and in Li ion pouch cells versus baseline production-quality counter-electrodes. Cell capacity were tested first at low C-rate on Maccor automated cycler. The cells were cycled at C/2 rate between 4.2-3.0 V. The NCA electrodes using the XLPVA binder show similar reversible capacity relative to NCA electrodes formed using PVdF as a binder. (185 mAh/g for XLPVA binder electrodes and 184 mAh/g for PVdF binder electrodes).

Various modifications of the present invention, in addition to those shown and described herein, will be apparent to those skilled in the art of the above description.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof.

1. An electrode for an electrochemical cell comprising:
an electrically conductive substrate, said substrate coated with an electrode active material intermixed with a crosslinked polyvinyl alcohol binder comprising a polymer and a crosslinker, the polymer characterized by a chemical structure capable of crosslinking in an aqueous solvent.

2. (canceled)

3. The electrode of claim 1 wherein said polymer is crosslinked with a crosslinker comprising a metal compound, an aldehyde, an organic acid, or combinations thereof.

4. The electrode of claim 1 wherein said polymer is crosslinked with a crosslinker comprising lithium, a metal borate, or combinations thereof.

5. The electrode of claim 4 wherein said crosslinker is Li₂B₄O₇.

6. The electrode of claim 1 wherein said binder comprises a polymer and a crosslinker wherein the molar ratio of said polymer to crosslinker is from 1:1 to 100:1.

7. The electrode claim 1 wherein said binder comprises a functionalized polyvinyl alcohol comprising polyvinyl alcohol polymer functionalized with a hydrophobic functional group of 1 to 6 carbons linked to said polyvinyl alcohol by an ether or ester bond.

8. The electrode of claim 1 wherein said binder comprises a functionalized polyvinyl alcohol comprising degree of hydrolysis of 70% or greater.

9. The electrode of claim 1 wherein said binder comprises one or more polyvinyl alcohol copolymers.

10. The electrode of claim 9 wherein said copolymer is a poly(vinyl alcohol-co-vinyl acetate) or poly(vinyl butyral-co-vinyl alcohol-co-vinyl acetate).

11. The electrode of claim 1 wherein said electrode active material comprises lithium, carbon, silicon, Fe, Ni, Co, Mn, Mg, Al, Ti, a rare earth metal, or combinations thereof.

12. The electrode of claim 1 wherein said electrode active material further comprises carbon.

13. A process of forming an electrode comprising:
combining an electrode active material with a binder comprising a polyvinyl alcohol and a crosslinker to form slurry, and
optionally coating an electrically conductive substrate with said slurry.

14. (canceled)

15. The process of claim 13 wherein said crosslinker is Li₂B₄O₇.

16. The process of claim 13 further comprising crosslinking said polymer and said crosslinker in the presence of said electrode active material prior to said step of coating.

17. The process of claim 13 further comprising partially crosslinking said polymer and said crosslinker in the presence of said electrode active material prior to said step of coating.

18. The process of claim 17 further comprising completing the crosslinking said polymer and said crosslinker following said step of coating.

19. The process of claim 17 wherein said step of crosslinking or partially crosslinking is in the presence of a pH adjusting agent.

20. The process of claim 13 wherein said step of combining is in the presence of an aqueous solvent.

21. The process of claim 20 where said aqueous solvent consists of water.

22. The process of claim 13 wherein said electrode active material comprises silicon, carbon, nickel, cobalt, manganese, iron, titanium, aluminum, or combinations thereof.

23. The process of claim 22 wherein said electrode active material comprises NCM-111, NCM-424, NCM-523, NCA, or LCO.

24. (canceled)

25. The process of claim 13 wherein said slurry has a viscosity of 100 cPs to 10000 cPs.

26. (canceled)

27. An electrochemical cell comprising:
an anode, a cathode, and a separator physically separating the cathode from the anode, the separator comprising a crosslinked polymer comprising a polyvinyl alcohol polymer and a crosslinker comprising lithium, a metal borate, or combinations thereof, the separator optionally comprising a ceramic filler.

28-38. (canceled)
